(19) United States
(12) Patent Application Publication
(10) Pub. No.: US 2009/0167753 A1
(43) Pub. Date: Jul. 2, 2009

(54) PLASMA DISPLAY PANEL AND DRIVING METHOD THEREOF

(75) Inventor: Moo-IL CHUNG, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/334,759

(22) Filed: Dec. 15, 2008

(30) Foreign Application Priority Data
Dec. 28, 2007 (KR) 2007-139984

(51) Int. Cl. G06F 3/038; G09G 3/28

(52) U.S. Cl. 345/214; 345/60

(57) ABSTRACT

A display panel and a driving method thereof capable of minimizing electromagnetic interference (EMI). A driving method of a display panel includes: sequentially supplying scan pulses to scan electrodes; and supplying data pulses separated by a time difference to at least two timing blocks while the scan pulses are supplied, each of the timing blocks including blocks of address electrodes, wherein the blocks of address electrodes supplied with the data pulses at a same time are separated by at least one block of address electrodes supplied with the data pulses at a time different from the same time by the time difference.

### CROSS-REFERENCE TO RELATED APPLICATIONS

This application claims the benefit of Korean Patent Application No. 2007-139984, filed on Dec. 28, 2007, in the Korean Intellectual Property Office, the entire content of which is incorporated herein by reference.

### BACKGROUND OF THE INVENTION

1. Field of the Invention

Aspects of the present invention relate to a plasma display panel and a driving method thereof, more in particular to a plasma display panel and a driving method thereof capable of minimizing electromagnetic interference (EMI).

2. Description of the Related Art

Recently, various flat panel display devices capable of reducing weight and volume, which are disadvantages of a cathode ray tube, have been developed. Examples of flat panel display devices include a liquid crystal display (LCD), a field emission display (FED), a plasma display panel (PDP), an organic light emitting display (OLED), etc.

The plasma display panel can be manufactured having a large screen so that it can be used for a large-sized TV. The plasma display panel divides one frame of a moving image into a plurality of subfields and displays an image while controlling a display time of an image according to weight values of the respective subfields. To this end, each subfield is divided into a reset period, an address period, and a sustain period.

Ramp pulses are supplied to scan electrodes during the reset period. Then, predetermined wall charges are formed in discharge cells so as to perform a subsequent address discharge stably. Scan pulses are sequentially supplied to scan electrodes during the address period, and data pulses are supplied to address electrodes. Then, an address discharge is generated in the discharge cells to which the data pulse was supplied so as to form the predetermined wall charges.

Sustain pulses are alternately supplied to the scan electrodes and sustain electrodes during the sustain period. Then, the sustain discharge is generated in the cell selected by the address discharge. Herein, a predetermined luminance of the image is displayed on the panel corresponding to the number of times the sustain discharge is generated.

In such a conventional plasma display panel the address discharge is simultaneously discharged in the plurality of discharge cells every time the scan pulses are supplied during the address period. If the address discharge is simultaneously generated in the plurality of discharge cells, a large amount of electromagnetic interference (EMI) occurs. In particular, when the plasma display panel is used as a full high definition display, array antenna radiation efficiency increases as the number of address electrodes increases.

### SUMMARY OF THE INVENTION

Aspects of the present invention provide a plasma display panel and a driving method thereof capable of minimizing EMI. According to aspects of the present invention, there is provided a driving method of a plasma display panel including: sequentially supplying scan pulses to scan electrodes; and supplying data pulses separated by a time difference to at least two timing blocks while the scan pulses are supplied, each of the timing blocks including blocks of address electrodes, wherein blocks of address electrodes supplied with the data pulses at a same time are separated by at least one block of address electrodes supplied with the data pulses at a time different from the same time by the time difference.

According to aspects of the present invention, the display panel is divided into at least four blocks. According to aspects of the present invention, the display panel includes a plurality of data integrated circuits to supply the data pulses to the address electrodes and is divided into the same number of blocks as the data integrated circuits. According to aspects of the present invention, the time difference may be 50 ns or more.

According to aspects of the present invention, there is provided a driving method of a plasma display panel including: sequentially supplying scan pulses to scan electrodes; and supplying data pulses to the timing blocks at different times while the scan pulses are supplied, the timing blocks comprising at least two blocks of address electrodes, wherein the at least two blocks of address electrodes included in each timing block are positioned to not be adjacent to each other. According to aspects of the present invention, the at least two blocks included in the timing block are positioned putting at least one block of address electrodes therebetween. According to aspects of the present invention, the data pulse is supplied at a time interval of at least 50 ns or more.

According to aspects of the present invention, there is provided a plasma display panel including: a scan driver to supply scan pulses to scan electrodes; address electrodes divided into a plurality of blocks, each block corresponding to a plurality of address electrodes; and an address driver to supply data pulses to the address electrodes according to the plurality of blocks as separated by a time difference while the scan pulses are supplied, wherein blocks supplied with the data pulses at a same time are separated by at least one block supplied with the data pulses at a time different from the same time by the time difference. According to aspects of the present invention, the time difference may be 50 ns or more.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a plasma display panel according to an embodiment of the present invention;

FIG. 2 is a view showing a plurality of blocks of a display panel according to an embodiment of the present invention;

FIGS. 3A and 3B are views showing a position of address electrodes supplied with data pulses;

FIG. 4 is a view showing data pulses supplied to a timing block while scan pulses are supplied; and

FIG. 5 is a view showing simulation results of a plasma display panel according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

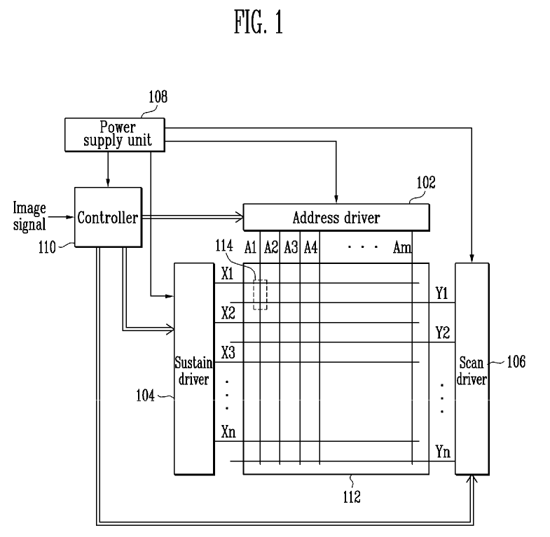

FIG. 1 is a view of a plasma display panel according to an embodiment of the present invention. Referring to FIG. 1, the plasma display panel according to an embodiment of the present invention includes a display panel 112, an address driver 102, a sustain driver 104, a scan driver 106, a power supply 108, and a controller 110.

The display panel 112 includes scan electrodes Y1 to Yn, sustain electrodes X1 to Xn formed to be parallel with the scan electrodes Y1 to Yn, and address electrodes A1 to Am formed in a direction to cross the scan electrodes Y1 to Yn and the sustain electrodes X1 to Xn. Herein, a discharge cell 114 is positioned at a portion of the display panel 112 in which the scan electrodes Y1 to Yn, the sustain electrodes X1 to Xn, and the address electrodes A1 to Am intersect. The electrodes X1, Y1, and Al, which intersect in the discharge cell 114, have a structure according to an embodiment of the present invention, but aspects of the present invention are not limited thereto.

A controller 110 receives an image signal from the outside and generates control signals to control the address driver 102, the sustain driver 104, and the scan driver 106. Herein, the controller 110 generates the control signals so that one frame can be divided and operated into a plurality of subfields each including a reset period, an address period, and a sustain period. The sustain driver 104 supplies the sustain pulses to the sustain electrodes X1 to Xn during the sustain period of each subfield according to the control signals supplied from the controller 110.

The scan driver 106 supplies ramp pulses to the scan electrodes Y1 to Yn during the reset period of each subfield according to the control signals supplied from the controller 110 and sequentially supplies scan pulses to the scan electrodes Y1 to Yn during the address period. Further, the scan driver 106 supplies sustain pulses to the scan electrodes Y1 to Yn which alternate with the sustain pulses supplied to sustain electrodes X1 to Xn during the sustain period by the sustain driver 104.

The power supply 108 supplies power required to drive the plasma display panel 112 to the controller 110 and the address, sustain, and scan drivers 102, 104, and 106.

The address driver 102 supplies data pulses to the address electrodes Al to Am during the address period of each subfield according to the control signals supplied from the controller 110. Accordingly, the address driver 102 selects a discharge cell, for example, the discharge cell 114, to be turned-on (or a discharge cell to be turned-off). The address driver 102 includes a plurality of integrated circuits (not shown). The data integrated circuits are coupled to i number (i is a natural number) of address electrodes to supply the data pulses to the i number of address electrodes.

The display panel 112 is divided into the plurality of blocks each including a plurality of address electrodes. The address driver 102 supplies the data pulses at different times in two blocks of the plurality of blocks. Further, the address driver 102 may supply the data pulses at different times according to a plurality of timing blocks into which the plurality of blocks is arranged.

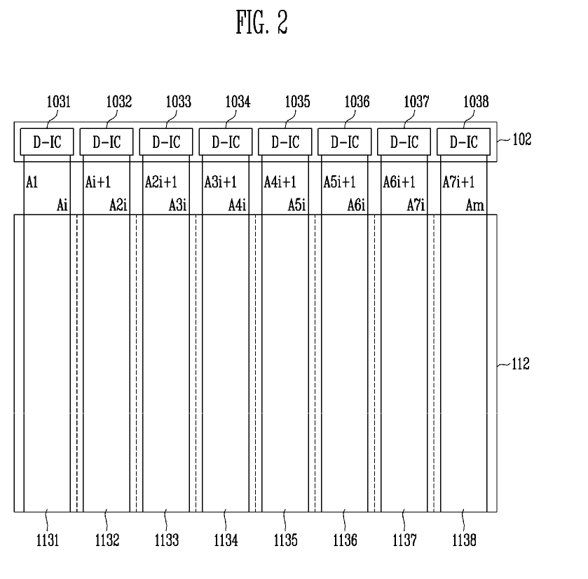

FIG. 2 is a view showing the plurality of blocks of the display panel according to an embodiment of the present invention. Hereinafter, aspects of the present invention are described with respect to the address driver 102 including 8 data integrated circuits; however, aspects of the present invention are not limited thereto such that the address drive 102 may include more or fewer data integrated circuits.

Referring to FIG. 2, the display panel 112 is divided into a plurality of blocks 1131 to 1138. Herein, the plurality of blocks 1131 to 1138 are divided into the same number of blocks as the data integrated circuits 1031 to 1038; however, aspects of the present invention are not limited thereto. In other words, each of the blocks 1131 to 1138 may be divided to include any number of address electrodes. Further, the data integrated circuits may correspond to blocks of address electrodes or to timing blocks including the blocks of address electrodes.

The first block 1131 includes the address electrodes A1 to Ai supplied with the data pulses from the first data integrated circuit 1031. The second block 1132 includes address electrodes Ai+1 to A2i supplied with the data pulses from the second data integrated circuit 1032. The third block 1133 includes address electrodes A2i+1 to A3i supplied with the data pulses from the third data integrated circuit 1033. The fourth block 1134 includes address electrodes A3i+1 to A4i supplied with the data pulses from the fourth data integrated circuit 1034. The fifth block 1135 includes address electrodes A4i+1 to A5i supplied with the data pulses from the fifth data integrated circuit 1035. The sixth block 1136 includes address electrodes A5i+1 to A6i supplied with the data pulses from the sixth data integrated circuit 1036. The seventh block 1137 includes address electrodes A6i+1 to A7i supplied with the data pulses from the seventh data integrated circuit 1037. The eighth block 1138 includes address electrodes A7i+1 to Am supplied with the data pulses from the eighth data integrated circuit 1038.

At least two blocks of the plurality of blocks 1131 to 1138 form timing blocks, and the data pulses are supplied at different times according to the timing blocks, thereby reducing the EMI. Herein, the timing blocks include at least two blocks of the plurality of blocks 1131 to 1138 supplied with the data pulses at the same time. At least two blocks of the plurality of blocks 1131 to 1138 included within one timing block are arranged not to be adjacent to each other, putting at least one block of the plurality of blocks 1131 to 1138 therebetween.

For example, the first block 1131 and the fifth block 1135 are set to a first timing block supplied with the data pulses at the same time, and the second block 1132 and the sixth block 1136 are set to a second timing block supplied with the data pulses at a different time from the first timing block. The third block 1133 and the seventh block 1137 are set to a third timing block supplied with the data pulses at a different time from the first timing block and the second timing block, and the fourth block 1134 and the eight block 1138 are set to a fourth timing block supplied with the data pulses at a different time from the first to third timing blocks.

In other words, the display panel 112 is sorted into the plurality of timing blocks and the data integrated circuits 1031 to 1038 supply the data pluses to the electrodes Al to Am at different times according to arrangement of the timing blocks. If the data pulses are supplied to the electrodes Al to Am at different times according to the timing blocks, the times in which the address discharges are generated are dispersed, thereby reducing the EMI. Further, the blocks of the plurality of blocks 1131 to 1138 included in the timing blocks are not adjacent, thereby further reducing the EMI.

On the other hand, a method of supplying the data pulses to the respective blocks 1131 to 1138 shown in FIG. 2 at different times may be included. However, if the data pulses are supplied to the plurality of blocks 1131 to 1138 at different times, the time in which the scan pulses is supplied is also increased. As the supply time of the scan pulses is increased, the address period is also increased.

Also, it is proposed that two blocks adjacent to each other may form one timing block. In other words, the first block 1131 and the second block 1132 may form one timing block, and the third block 1133 and the fourth block 1134 may form one timing block. However, when the adjacent blocks form one timing block, the discharge cells generating the address discharge are adjacent so that the EMI is not sufficiently reduced. Therefore, the blocks included in the timing block are not adjacent to each other so as to reduce the EMI.

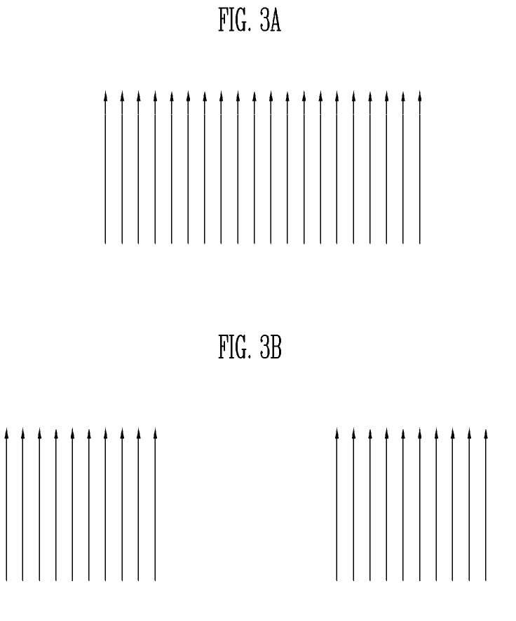

In detail, when the data pulse (that is, predetermined voltage) is supplied to the address electrodes A1-Am, each of the address electrodes A1-Am may be modeled as a monopole antenna. Herein, the address electrodes A1-Am which are simultaneously supplied with the data pulses are equivalently modeled as an array monopole antenna. In the case of the monopole antenna, if current is applied, a magnetic field is formed thereabout according to a frequency. In this case, if the address electrodes A1-Am are supplied with the same data pulses and are adjacent to each other as shown in FIG. 3A, the individual magnetic fields of each of the address electrodes A1-Am combine to form a larger magnetic field, thereby raising the EMI level. However, if the address electrodes A1-Am are supplied with the same data pulses and are separated from each other, as shown in FIG. 3B, the intensity of the magnetic field is lowered which decreases the EMI level.

FIG. 4 is a timing diagram showing the data pulses supplied to the timing blocks while the scan pulses are supplied. Referring to FIG. 4, while the scan pulses are supplied to the scan electrodes Y1 to Yn, each of the timing blocks is supplied with the data pulses at a different time. At this time, the data pulses between the timing blocks maintain an interval of a first period T1, e.g., about 50 ns. The data pulses supplied between the timing blocks are required to maintain the interval of 50 ns or more to effectively reduce the EMI. If the interval of the data pulses between the timing blocks is set below 50 ns, the EMI is not significantly reduced.

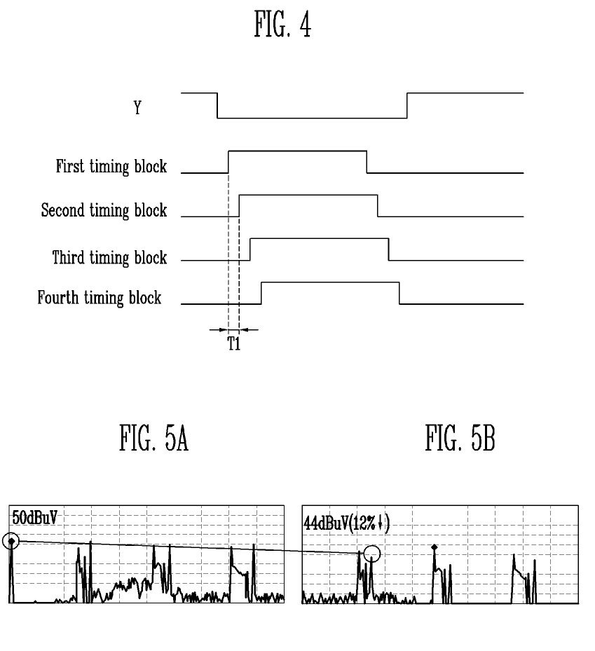

FIGS. 5A and 5B are a graphs showing EMI reduction according to aspects of the present invention. FIG. 5A illustrates the EMI occurring when the display panel 112 divided into two blocks is supplied with the data pulses to at different times, and FIG. 5B illustrates the EMI occurring when the display panel 112 divided into four blocks is supplied with the data pulses to at different times.

Referring to FIG. 5A, in the case where the display panel 112 is divided into two blocks, the EMI of about 50 dBuV is emitted. However, when the display panel 112 is divided into eight blocks and simultaneously supplies the data pulses to two blocks separated from each other, the EMI of about 44 dBuV is emitted, as shown in FIG. 5B. In other words, the EMI is decreased by about 12% or more as compared with the case where the display panel 112 is divided into two blocks.

Although, the description above is made with reference to a display panel having eight data integrated circuits 1031 to 1038, aspects of the present invention are not limited thereto. For example, in the case of a Full HD-grade display panel 112, twelve data integrated circuits may be installed. In such case, the display panel 112 may be divided into twelve blocks and three timing blocks may be used. Accordingly, the EMI can be effectively reduced without increasing the length of time of the address period.

As described above, the plasma display panel and the driving method thereof according to aspects of the present invention divides the display panel into the plurality of blocks and simultaneously supplies data pulses to at least two blocks which are separated from each other, thereby reducing the EMI.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A driving method of a display panel, the method comprising:
sequentially supplying scan pulses to scan electrodes; and
supplying data pulses, separated by a time difference, to at least two timing blocks while the scan pulses are supplied, each of the timing blocks including blocks of address electrodes, wherein blocks of address electrodes supplied with the data pulses at a same time are separated by at least one block of address electrodes supplied with the data pulses at a time different from the same time by the time difference.

2. The driving method of claim 1, wherein the display panel is divided into at least four blocks of address electrodes.

3. The driving method of claim 2, wherein the display panel includes a plurality of data integrated circuits supplying the data pulses to the address electrodes, each of the plurality of data integrated circuits corresponding to a block of address electrodes.

4. The driving method of claim 1, wherein the time difference is 50 ns or more.

5. The driving method of claim 1, wherein the supplying of the data pulses comprises supplying the data pulses to a first timing block of the at least two timing blocks at a first time, and supplying the data pulses to a second timing block of the at least two timing blocks at a second time, the first and second times being separated by the time difference.

6. A driving method of a display panel, the method comprising:
sequentially supplying scan pulses to scan electrodes; and
supplying data pulses at different times per timing blocks while the scan pulses are supplied, the timing blocks comprising at least two blocks of address electrodes,
wherein the at least two blocks of address electrodes included in each timing block are positioned to be not adjacent to each other.

7. The driving method of claim 6, wherein the at least two blocks of address electrodes included in each timing block are positioned such that at least one block of address electrodes of another timing block is disposed therebetween.

8. The driving method of claim 6, wherein the data pulse is supplied at an interval of at least 50 ns or more.

9. A display panel, comprising:
a scan driver to supply scan pulses to scan electrodes;
address electrodes divided into a plurality of blocks, each block corresponding to a plurality of the address electrodes;
an address driver to supply data pulses to the address electrodes according to the plurality of blocks as separated by a time difference while the scan pulses are supplied, wherein blocks supplied with the data pulses at a same time are separated by at least one block supplied with the data pulses at a time different from the same time by the time difference.

10. The display panel of claim 9, wherein the time difference is 50 ns or more.

11. A driving method of a display panel, the method comprising:
sequentially supplying scan pulses to scan electrodes;
supplying data pulses to a first timing block while the scan pulses are supplied to the scan electrodes, the first timing block comprising at least two blocks of address electrodes; and
supplying data pulses to a second timing block while the scan pulses are supplied to the scan electrodes at a first time difference after the supplying of the data pulses to the first timing block,
wherein at least one block of address electrodes of the second timing block is disposed between two of the blocks of the address electrodes of the first timing block.

12. The driving method of claim 11, further comprising:
supplying data pulses to a third timing block while the scan pulses are supplied to the scan electrodes at a second time difference after the supplying of the data pulses to the second timing block,
wherein at least one block of address electrodes of the third timing block is disposed between the at least one block of address electrodes of the second timing block and one of the two blocks of the address electrodes of the first timing block.

13. The driving method of claim 12, wherein the first and second time differences are equal.

14. The driving method of claim 12, wherein the first and the second time differences are 50 ns or greater.

15. The driving method of claim 12, further comprising:
supplying data pulses to a fourth timing block while the scan pulses are supplied to the scan electrodes at a third time difference after the supplying of the data pulses to the third timing block,
wherein at least one block of address electrodes of the fourth timing block is disposed between the at least one block of address electrodes of the third timing block and the one of the two blocks of the address electrodes of the first timing block.

16. The method of claim 15, wherein the first, second, and third time differences are equal.

17. The method of claim 15, wherein the first, second, and third time differences are 50 ns or greater.

18. A display panel, comprising:
a scan driver to supply scan pulses to scan electrodes;
an address driver to supply data pulses to address electrodes, the address driver comprising a plurality of driving integrated circuits each corresponding to a timing block to supply the data pulses, separated by a time difference, to the timing blocks while the scan driver supplies the scan pulses, the timing blocks including blocks of the address electrodes, and the blocks of the address electrodes of the timing blocks are interposed with the blocks of the address electrodes of the other timing blocks.

19. The display panel of claim 18, wherein the plurality of driving integrated circuits corresponds to the blocks of the address electrodes of the timing blocks.
